(19) United States
(12) Patent Application Publication
(10) Pub. No.: US 2026/0106803 A1
(43) Pub. Date: Apr. 16, 2026

(54) SERVER SYSTEM

(71) Applicant: TOYOTA JIDOSHA KABUSHIKI KAISHA, Toyota-shi (JP)

(72) Inventor: Takamasa Higuchi, Tokyo (JP)

(73) Assignee: TOYOTA JIDOSHA KABUSHIKI KAISHA, Toyota-shi (JP)

(21) Appl. No.: 19/297,320

(22) Filed: Aug. 12, 2025

(30) Foreign Application Priority Data
Oct. 11, 2024 (JP) 2024-178756

(51) Int. Cl. H04L 41/147; H04L 41/0816

(52) U.S. Cl. CPC H04L 41/147; H04L 41/0816

(57) ABSTRACT

A server system includes a plurality of prediction servers, and a mediation server that mediates transfer of data among the prediction servers. One prediction server includes an acquisition unit that acquires a communication service log regarding one partial communication area, a prediction unit that predicts future communication service quality of the one partial communication area based on the communication service log, and a communication unit that transmits a first prediction result by the prediction unit to the mediation server and selectively receives a second prediction result by another prediction server from the mediation server. The prediction unit predicts communication service quality between one node within the one partial communication area and another node within another partial communication area using the first prediction result and the second prediction result.

### CROSS-REFERENCE TO RELATED APPLICATION

This application claims priority to Japanese Patent Application No. 2024-178756 filed on Oct. 11, 2024. The disclosure of the above-identified application, including the specification, drawings, and claims, is incorporated by reference herein in its entirety.

### BACKGROUND

### 1. Technical Field

The present disclosure relates to a technical field of a server system that predicts communication quality.

### 2. Description of Related Art

As this type of system, for example, a system that estimates wireless quality in a service area using a radio wave propagation simulator and predicts deterioration of wireless quality at a future position of a wireless terminal has been proposed (see Japanese Unexamined Patent Application Publication No. 2009-278421 (JP 2009-278421 A)).

### SUMMARY

A digital twin in which artificial intelligence (AI) performs analysis and simulation on a virtual space using data collected in a real space and performs feedback to the real space has been proposed. To implement a digital twin in the technical field of communication services, for example, it is necessary to collect, accumulate and analyze an enormous amount of communication service logs. Thus, overhead regarding data collection becomes a problem.

The present disclosure has been made in view of the above-described problem and is directed to providing a server system capable of reducing overhead regarding data collection.

A server system according to one aspect of the present disclosure is a server system including a plurality of prediction servers that predicts communication service quality of partial communication areas that each of the prediction servers is respectively responsible for, and a mediation server that mediates transfer of data among the prediction servers, in which one prediction server among the prediction servers includes an acquisition unit that acquires a communication service log regarding one partial communication area that the one prediction server is responsible for, a prediction unit that predicts first communication service quality that is future communication service quality of the one partial communication area based on the communication service log, and a communication unit that transmits a first prediction result indicating the first communication service quality to the mediation server and selectively receives a second prediction result predicted by another prediction server among the prediction servers from the mediation server, the prediction unit predicts second communication service quality that is future communication service quality between one node within the one partial communication area and another node within another partial communication area that the other prediction server is responsible for using at least one of the first prediction result or the second prediction result, and the server system further includes an instruction unit that instructs the one node to change a communication setting when the second communication service quality is lower than a predetermined quality.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating concept of a server system according to an embodiment; and

FIG. 2 is a block diagram illustrating a configuration of the server system according to the embodiment.

### DETAILED DESCRIPTION OF EMBODIMENTS

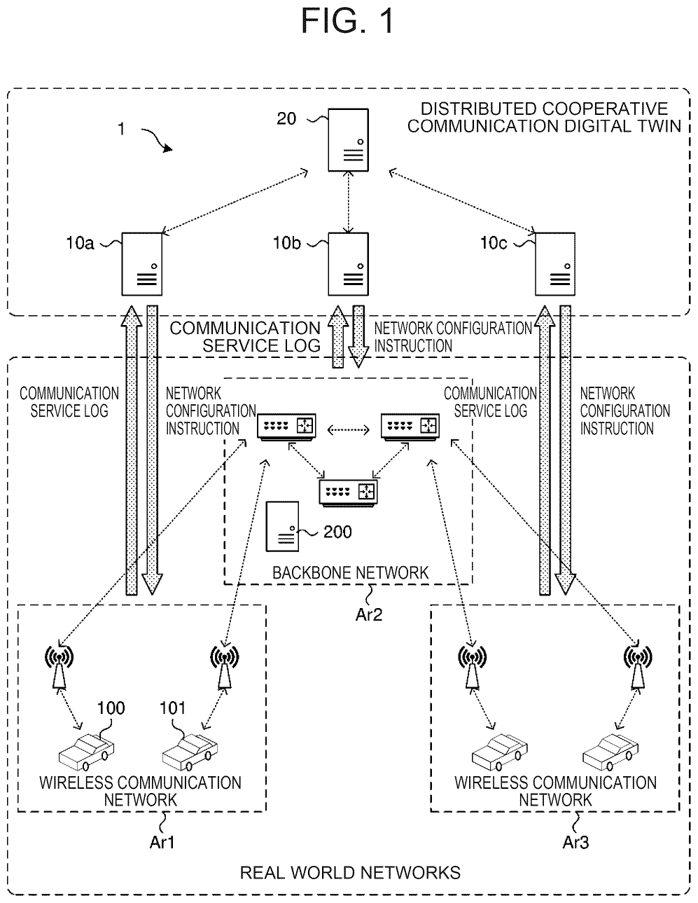

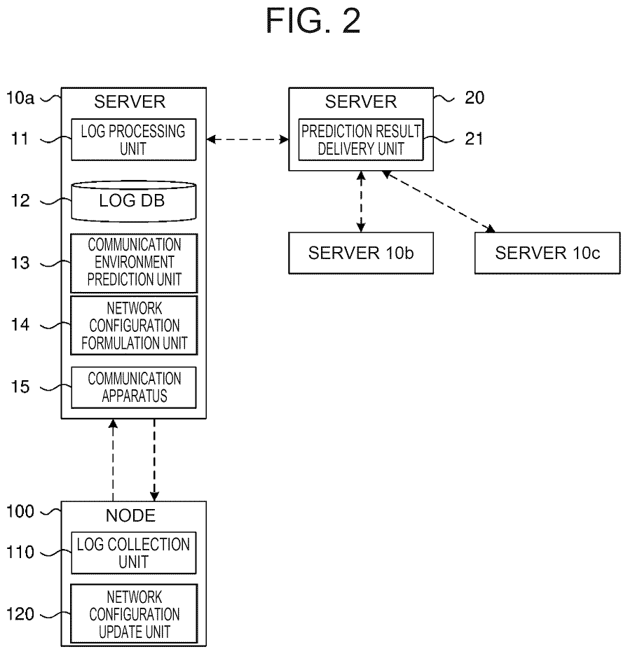

An embodiment according to a server system will be described with reference to FIG. 1 and FIG. 2.

In FIG. 1, a server system 1 includes servers 10a, 10b, 10c, and a server 20. The servers 10a, 10b, 10c and the server 20 are configured to be able to perform communication with each other. For example, message queue telemetry transport (MQTT) may be used as communication protocol between the servers 10a, 10b, 10c and the server 20. In other words, the server system 1 may be a publish-subscribe-type system. Note that the number of servers provided in the server system 1 is one example and is not limited to this.

The server 10a may acquire a communication service log from each node included in a communication area Ar1. The server 10a may reproduce a communication environment of the communication area Ar1 on a virtual space using the acquired communication service log. The server 10b may acquire a communication service log from each node included in a communication area Ar2. The server 10b may reproduce a communication environment of the communication area Ar2 on a virtual space using the acquired communication service log. The server 10c may acquire a communication service log from each node included in a communication area Ar3. The server 10c may reproduce a communication environment of the communication area Ar3 on a virtual space using the acquired communication service log. Note that the servers 10a, 10b, 10c may be referred to as “digital twin servers”.

For example, the node may be a vehicle having a communication function, a relay device, a server device, or the like. Note that the vehicle having the communication function may be a connected car. For example, a communication service log related to the vehicle as the node may include at least one of a position of the vehicle, communication history, communication quality or a response delay of the server. Note that the position of the vehicle may read as a position of a communication device. Note that each of the communication areas Ar1, Ar2, Ar3 may be set based on at least one of a cell covered by one wireless base station or an area controlled by an accommodation station provided upstream of each wireless base station.

The server 20 mediates transfer of data among the servers 10a, 10b, 10c. For example, the server 20 may transmit data acquired from the server 10a to at least one of the server 10b or 10c. The server 20 may transmit data acquired from the server 10b to at least one of the server 10a or 10c. The server 20 may transmit data acquired from the server 10c to at least one of the server 10a or 10b. Note that the server 20 may be referred to as a “digital twin broker”.

Operation of the server system 1 will be described next with reference to FIG. 2 in addition to FIG. 1. In FIG. 2, the server 10a includes a log processing unit 11, a log database 12, a communication environment prediction unit 13, a network configuration formulation unit 14, and a communication apparatus 15. The server 20 includes a prediction result delivery unit 21. Note that the servers 10b, 10c may have a configuration similar to the configuration of the server 10a. A vehicle 100 as the node includes a log collection unit 110 and a network configuration update unit 120.

The log collection unit 110 of the vehicle 100 may transmit a communication service log to the server 10a responsible for the communication area Ar1 in which the vehicle 100 exists. The communication service log related to the vehicle 100 as the node may include, for example, history of position information of the vehicle 100, an amount of communication data transmitted/received by the vehicle 100, a throughput/latency at that time, intensity and a signal-to-noise ratio (S/N ratio) of a signal received by the vehicle 100 from a wireless base station, a data processing delay and a load level of the server, and the like. Note that the log collection unit 110 may regularly transmit the communication service log to the server 10a.

The log processing unit 11 of the server 10a may acquire the communication service log transmitted from the vehicle 100. The log processing unit 11 may further acquire communication service logs transmitted from nodes other than the vehicle 100 included in the communication area Ar1. The log processing unit 11 may perform predetermined processing on or tally the communication service logs acquired from a plurality of nodes included in the communication area Ar1. The log processing unit 11 may store a tally result in the log database 12. Note that in the log database 12, past tally results may be stored in addition to the latest tally result.

The communication environment prediction unit 13 of the server 10a may, for example, predict future behavior of the vehicle 100 as the node and communication performance between the nodes (for example, the vehicle 100 and a vehicle 101) within the communication area Ar1 based on the tally results of the communication service logs stored in the log database 12. In other words, the communication environment prediction unit 13 may predict future communication service quality of the communication area Ar1. In this case, the communication environment prediction unit 13 may use AI that outputs future behavior of the vehicle 100 and communication performance between the nodes within the communication area Ar1 by receiving inputs of the tally results of the communication service logs.

Note that the future behavior of the vehicle 100 may include a movement trajectory of the vehicle 100, a communication amount, a communication timing, and the like. Note that the position of the vehicle 100 (for example, the movement trajectory of the vehicle 100) may be predicted by utilizing a prediction algorithm described in Nachiket Deo, Mohan M. Trivedi; Convolutional Social Pooling for Vehicle Trajectory Prediction, in Proceedings of the IEEE Conference on Computer Vision and Pattern Recognition (CVPR) Workshops, 2018, pp.1581-1589. Note that the communication quality may be predicted by utilizing a radio propagation simulator, a communication simulator, or the like, or may be predicted using regression analysis, machine learning, or the like.

The communication apparatus 15 may transmit a first prediction result that is the prediction result of the communication environment prediction unit 13 to the server 20. The server 20 may store the first prediction result transmitted from the server 10a in a storage apparatus (not illustrated). The prediction result delivery unit 21 of the server 20 may transmit the first prediction result to at least one of the server 10b or 10c. For example, a topic regarding the first prediction result may be associated with the first prediction result. The prediction result delivery unit 21 may transmit the first prediction result to a server in which the topic associated with the first prediction result is registered between the servers 10b, 10c based on the topic associated with the first prediction result. Note that when there is no server in which the topic associated with the first prediction result is registered, the prediction result delivery unit 21 may discard the first prediction result.

The server 10b may predict future communication service quality of the communication area Ar2 based on the communication service logs (for example, the tally result of the communication service logs). The server 10b may transmit a second prediction result indicating the predicted communication service quality to the server 20. The prediction result delivery unit 21 of the server 20 may transmit the second prediction result to at least one of the server 10a or 10c.

The server 10c may predict future communication service quality of the communication area Ar3 based on the communication service logs (for example, the tally result of the communication service logs). The server 10c may transmit a third prediction result indicating the predicted communication service quality to the server 20. The prediction result delivery unit 21 of the server 20 may transmit the third prediction result to at least one of the server 10a or 10b.

For example, the communication environment prediction unit 13 of the server 10a may predict future communication service quality between the vehicle 100 as the node within the communication area Ar1 and a server 200 (see FIG. 1) as the node within the communication area Ar2. In this case, the communication apparatus 15 of the server 10a may receive the prediction result (for example, the second prediction result described above) of the server 10b responsible for the communication area Ar2 from the server 20. Note that the communication apparatus 15 may receive prediction results of communication service quality of one or more servers that are responsible for respective nodes on a communication path between the vehicle 100 and the server 200 from the server 20 in addition to the prediction result of the server 10b.

For example, the communication environment prediction unit 13 of the server 10a may predict future communication service quality between the vehicle 100 and the server 200 using at least one of future communication service quality (for example, the first prediction result described above) of the communication area Ar1 or the prediction result (for example, the second prediction result described above) of the server 10b. The communication service quality may include an end-to-end delay. The communication environment prediction unit 13 may input a fourth prediction result indicating future communication service quality between the vehicle 100 and the server 200 to the network configuration formulation unit 14.

The network configuration formulation unit 14 may determine whether or not the communication service quality indicated by the fourth prediction result satisfies a required predetermined quality. When the communication service quality indicated by the fourth prediction result is lower than the predetermined quality, the network configuration formulation unit 14 may transmit a network configuration instruction to the vehicle 100 via the communication apparatus 15. Note that when the communication service quality indicated by the fourth prediction result satisfies the predetermined quality, the network configuration formulation unit 14 does not have to output the network configuration instruction. For example, the network configuration instruction may include at least one of update of a routing table, change of a communication destination application server, change of communication means, change of a transmission frequency of data, or a degree of detail and a compression ratio of transmission data.

For example, as a result of the routing table being updated, it can be expected that a communication traffic is transferred so as to avoid a congested network segment. For example, as a result of the communication destination application server being changed, it can be expected that a server assumed to have a low end-to-end delay is selected. For example, change of the communication means may include at least one of switching between or combination use of different cellular networks and at least one of switching between or combination use of different types of communication networks (such as Wi-Fi (registered trademark) and satellite communication).

The network configuration update unit 120 of the vehicle 100 as the node, which has received the network configuration instruction, may reflect the network configuration instruction in communication control.

Note that the server 10a may transmit a prediction result indicating newly predicted communication service quality to the server 20 via the communication apparatus 15 every time the communication environment prediction unit 13 predicts future communication service quality of the communication area Ar1. When the server 10a transmits the new prediction result to the server 20, the server 10a may delete the past prediction result related to the communication area Ar1 from the server 20.

For example, when the server system 1 is a publish-subscribe-type system, the server 10a may selectively receive only a prediction result to be utilized by the server 10a from the server 20 among a plurality of prediction results indicating communication service quality predicted by other servers (for example, at least one of the server 10b or 10c). This can reduce communication overhead.

### Technical Effects

In the server system 1, the servers 10a, 10b, 10c collect communication service logs regarding the communication areas Ar1, Ar2, Ar3 that the servers 10a, 10b, 10c are respectively responsible for. For example, compared to a server system in which only one server collects communication service logs, the server system 1 according to the present embodiment can reduce overhead regarding data collection.

In other words, it is necessary to collect an enormous amount of communication service logs from respective nodes on a network without delay to predict communication service quality such as reception quality of a radio wave, a congestion degree of the network and processing load of a server with high accuracy. In the server system 1 according to the present embodiment, the plurality of servers 10a, 10b, 10c is distributed to perform prediction processing of communication service quality, so that it is possible to narrow a range in which each of the servers 10a, 10b, 10c collects communication service logs. This results in making it possible for the server system 1 to reduce overhead regarding data collection.

Aspects of the disclosure derived from the embodiment described above will be described below.

A server system according to one aspect of the disclosure is a server system including a plurality of prediction servers that predicts communication service quality of partial communication areas that each of the prediction servers is respectively responsible for, and a mediation server that mediates transfer of data among the prediction servers, in which one prediction server among the prediction servers includes an acquisition unit that acquires a communication service log regarding one partial communication area that the one prediction server is responsible for, a prediction unit that predicts first communication service quality that is future communication service quality of the one partial communication area based on the communication service log, and a communication unit that transmits a first prediction result indicating the first communication quality service to the mediation server and selectively receives a second prediction result predicted by another prediction server among the prediction servers from the mediation server, the prediction unit predicts second communication service quality that is future communication service quality between one node within the one partial communication area and another node within another partial communication area that the other prediction server is responsible for using at least one of the first prediction result or the second prediction result, and the server system further includes an instruction unit that instructs the one node to change a communication setting when the second communication service quality is lower than a predetermined quality.

In the above-described embodiment, the “servers 10a, 10b, 10c” correspond to one example of the “prediction server”, the “server 10b” corresponds to one example of the “mediation server”, the “log processing unit 11” corresponds to one example of the “acquisition unit”, the “communication environment prediction unit 13” corresponds to one example of the “prediction unit”, the “communication apparatus 15” corresponds to one example of the “communication unit”, and the “network configuration formulation unit 14” corresponds to one example of the “instruction unit”.

In one example of the server system, the one node may be a vehicle having a communication function.

The present disclosure is not limited to the above-described embodiment and can be changed as appropriate in a range not deviating from the gist or idea of the disclosure interpreted from the claims and the entire specification, and a server system associated with such change is also incorporated into a technical scope of the present disclosure.

What is claimed is:

1. A server system comprising:
a plurality of prediction servers that predicts communication service quality of partial communication areas that each of the prediction servers is respectively responsible for; and
a mediation server that mediates transfer of data among the prediction servers, wherein:
one prediction server among the prediction servers comprises:
an acquisition unit that acquires a communication service log regarding one partial communication area that the one prediction server is responsible for;
a prediction unit that predicts first communication service quality that is future communication service quality of the one partial communication area based on the communication service log; and
a communication unit that transmits a first prediction result indicating the first communication service quality to the mediation server and selectively receives a second prediction result predicted by another prediction server among the prediction servers from the mediation server;
the prediction unit predicts second communication service quality that is future communication service quality between one node within the one partial communication area and another node within another partial communication area that the other prediction server is responsible for using at least one of the first prediction result or the second prediction result; and
the server system further comprises an instruction unit that instructs the one node to change a communication setting when the second communication service quality is lower than a predetermined quality.

2. The server system according to claim 1, wherein the one node is a vehicle having a communication function.
